(19) United States
(12) Patent Application Publication
(10) Pub. No.: US 2020/0302756 A1
(43) Pub. Date: Sep. 24, 2020

(54) PRINTING DEVICE, METHOD OF PRINTING, AND STORAGE MEDIUM

(71) Applicant: CASIO COMPUTER CO., LTD., Tokyo (JP)

(72) Inventor: Katsuyuki ITAKURA, Tokyo (JP)

(73) Assignee: CASIO COMPUTER CO., LTD., Tokyo (JP)

(21) Appl. No.: 16/806,413

(22) Filed: Mar. 2, 2020

(30) Foreign Application Priority Data
Mar. 19, 2019 (JP) 2019-051970

(51) Int. Cl. G07G 1/00; G07G 1/12; G07G 5/00

(52) U.S. Cl. CPC G07G 1/0018; G07G 5/00; G07G 1/12

(57) ABSTRACT

A printing device includes a memory; and a processor that executes a memory control process of sequentially storing input data that are input by a user sequentially via an input unit in the memory as printing data for a form in the order the input data are input; and a printing control process of selectively starting, in accordance with an amount of free space in the memory, one of a print-from-beginning printing in which the printing data are printed in a same order as the order the input data are input such that a feed-out direction of the printing paper becomes an upwards direction of the form and a print-from-end printing in which the printing data are printed in a reversed order relative to the order the input data are input such that the feed-out direction of the printing paper becomes a downwards direction of the form.

### TECHNICAL FIELD

The present invention relates to a printing device, a method of printing, and a storage medium.

### BACKGROUND ART

Sales data processing devices such as electronic cash registers (ECRs) which register sales data such as the prices and quantities of products sold to customers are conventionally installed in stores and used when processing sales. Sales data processing devices of this type are equipped with a thermal printer for issuing the details of a sale as a receipt.

For example, when a cashier (user) inputs the product name or price of a product sold to a customer in a business transaction via prescribed operation keys, that input information is sequentially printed from the end of a continuous paper which is wound up in a rolled state (Japanese Patent Application Laid-Open Publication No. H10-111983, for example).

A conventional sales data processing device of the type described above is configured such that the printed receipt is conveyed towards the side of the cashier who is operating that sales data processing device, thereby resulting in a design that allows the cashier to easily take the conveyed receipt into hand. However, on the conveyed receipt, the information input via the operation keys is sequentially printed with the end on the conveyance direction side being the top. As a result, in the conveyed state the receipt appears to be vertically inverted to the cashier, and in order to check the details of the printed information the conveyed receipt must be turned around vertically after being taken into hand.

In regards to this problem, it would be conceivable to store the input information in a memory as printing data for the receipt so as to then issue the receipt with the end on the conveyance direction side being the bottom. However, with this type of approach, it becomes necessary to print starting from information that is input later. In other words, information that is input earlier needs to remain stored in memory until all input related to the business transaction is complete. As a result, for sales data processing devices with low memory capacity, there was also a problem of there being cases in which it would not be possible to print adequately.

### SUMMARY OF THE INVENTION

In one aspect, the present disclosure provides a printing device, comprising: a memory; and a processor that executes the following processes: a memory control process of sequentially storing input data that are input by a user sequentially via an input unit in the memory as printing data for a form in the order the input data are input; and a printing control process of, when starting to print the printing data stored in the memory on a printing paper, selectively starting, in accordance with an amount of free space in the memory, one of a print-from-beginning printing in which the printing data are printed in a same order as the order the input data are input such that a feed-out direction of the printing paper becomes an upwards direction of the form and a print-from-end printing in which the printing data are printed in a reversed order relative to the order the input data are input such that the feed-out direction of the printing paper becomes a downwards direction of the form.

In another aspect, the present disclosure provides a method of printing executed by a process in the printing device having a memory and said processor, said process performing the above-described processes.

In another aspect, the present disclosure provides a non-transitory computer-readable storage medium having stored thereon a program executable by a processor of a printing device that has a memory and said processor, the program causing the processor to perform the above-describe processes.

Additional or separate features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

It is to be understood that both the foregoing general description and the following detailed description are exemplary and explanatory, and are intended to provide further explanation of the invention as claimed.

### BRIEF DESCRIPTION OF THE DRAWINGS

FIG. 1 is a perspective view for explaining the overall configuration of a sales data processing device according to an embodiment of the present invention.

FIG. 2 is a schematic block diagram for explaining an internal configuration of the sales data processing device according to the embodiment.

FIG. 3 is a plan view of a mode switch formed in an upper portion of the sales data processing device of the embodiment.

FIG. 4 is a cross-sectional view taken at a position along line IV-IV in FIG. 1 and illustrating the configuration of a printing unit in the sales data processing device of the embodiment.

FIG. 5 is a plan view illustrating an example of a receipt printed from the beginning and fed out from the printing unit of the sales data processing device of the embodiment.

FIG. 6 is a plan view illustrating an example of a receipt printed from the end and fed out from the printing unit of the sales data processing device of the embodiment.

FIG. 7 illustrates the configuration of a memory of the sales data processing device of the embodiment and provides a schematic visualization of the space in RAM.

FIG. 8 is a flowchart for explaining the flow of operations in a mode switching process of the sales data processing device of the embodiment.

FIG. 9 is a flowchart for explaining the flow of operations in a receipt issuing process of the sales data processing device of the embodiment.

### DETAILED DESCRIPTION OF EMBODIMENTS

Next, an embodiment of the present invention will be described with reference to figures as appropriate. Components that are the same will be given the same reference characters, and redundant descriptions of such components will be omitted.

### Embodiment

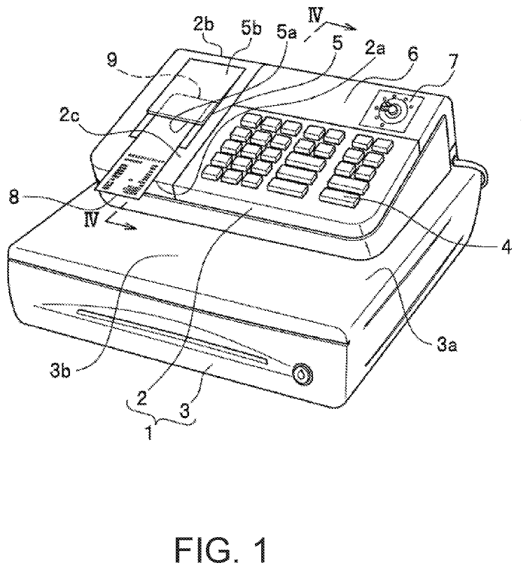

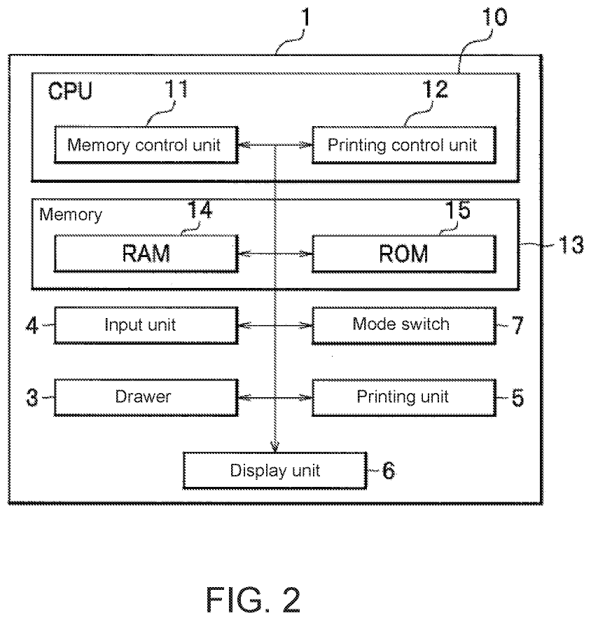

As illustrated in FIG. 1, a sales data processing device 1 (a printing device to which a method of printing according to the present embodiment will be applied) primarily includes a case 2 which houses a computer such as a central processing unit (CPU) 10 (illustrated in FIG. 2) and a box-shaped drawer 3 which has a cash drawer.

The area required to mount the case 2 is less than the area of an upper surface 3a of the drawer 3. The case 2 is mounted along the rear side of the upper surface 3a of the drawer 3. Moreover, a flat currency inspection space 3b is formed in the upper surface 3a in front of the cashier side of the case 2.

An upper surface 2c of the case 2 is given a prescribed angle of inclination so as to slant downwards going towards the front direction. An input unit 4 having a plurality of input keys and a printing unit 5 which feeds out a receipt 8 are provided on the upper surface 2c. Moreover, a display 6 which can display calculation results from the CPU 10 and a mode switch 7 for mode selection are also provided on the upper surface 2c.

Among these components, the printing unit 5 includes, as illustrated in FIG. 4 (described later), a spooler 5d which spools a continuous paper 9 as printing paper that is wound up in a rolled state, a recessed area 5g which houses the spooler 5d, a thermal printer 5c which prints printing data, and a feed roller 5e which feeds out the continuous paper 9 once printed.

The thermal printer 5c prints printing data onto the continuous paper 9 in accordance with calculation results from the CPU 10. The continuous paper 9 is cut by a cutter 5f and fed out as the receipt 8.

The printing unit 5 has a horizontally elongated slit-shaped feed-out opening 5a in the upper surface 2c. The feed-out opening 5a of the present embodiment is formed opening along a lower edge 2a of the case 2. The feed-out opening 5a is not particularly limited to this configuration and may also be formed opening along an upper edge 2b of the case 2.

Moreover, the receipt 8 fed out from the feed-out opening 5a is given an angle of inclination running along the upper surface 2c and slides down along the upper surface of the currency inspection space 3b with the printed side facing the cashier. As a result of the feed-out opening 5a being formed near the lower edge 2a, the receipt 8 that is fed out from the feed-out opening 5a is close to the cashier and easily visible.

Furthermore, above the area in which the continuous paper 9 is housed, the printing unit 5 of the present embodiment has a resting space 5b in which mobile computing devices such as smartphones or tablets can be rested. The resting space 5b is given a prescribed angle of inclination such that a flat resting surface near the upper side runs along the angle of inclination of the upper surface 2c. This makes it possible for mobile computing devices that are rested in the resting space 5b to be oriented with the display surface of the device facing the cashier. In the present embodiment, forming the feed-out opening 5a near the lower edge 2a makes it possible to increase the area of the resting space 5b.

As illustrated in FIG. 2, inside the sales data processing device 1, the drawer 3, the input unit 4, the printing unit 5, the display unit 6, the mode switch 7, and a memory 13 are connected to the central processing unit (CPU) 10. The CPU 10 includes a memory control unit 11 and a printing control unit 12. These components are configured so as to be able to read and write programs and data to and from the memory 13. The memory 13 includes a random-access memory (RAM) 14 and a read-only memory (ROM) 15.

Among these, the RAM 14 of the present embodiment can store sales register data related to a transaction input by the user via the input unit 4 as printing data for a receipt. Then, the printing data stored in the RAM 14 is read under the control of the printing control unit 12 and is sent to the printing unit 5. Printing data stored in the RAM 14 is maintained until the transaction is complete.

Furthermore, the ROM 15 stores programs to be executed by the CPU 10, settings data, and sales register data registered on the sales data processing device 1. A storage device that does not require electrical power to keep data stored, such as a hard disk drive (HDD), solid-state drive (SSD), or flash memory, for example, is used for the ROM 15.

The drawer 3 is locked and unlocked as necessary under the control of the CPU 10. Moreover, the cash drawer may be opened and closed as necessary under the control of the CPU 10.

The input unit 4 includes at least a numeric keypad for inputting numbers, a subtotal key, and a registration key. A scanner for reading barcodes may also be included.

The printing unit 5 prints registered printing data on an upper surface 9a side of the continuous paper 9 in accordance with instructions from the CPU 10.

The continuous paper 9 that has been printed by the thermal printer 5c is fed out from the feed-out opening 5a by the feed roller 5e and is then cut by the cutter 5f to become a receipt 8.

The display unit 6 includes a liquid crystal display device or the like. The display unit 6 displays data input via the input unit 4, data calculated by the CPU 10, and the like in a state that is visible to at least the cashier.

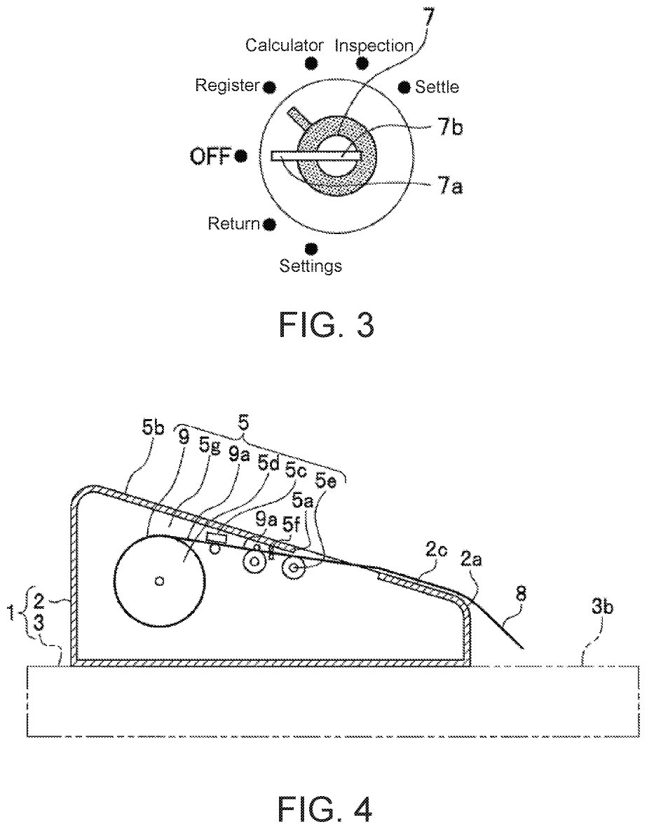

As illustrated in FIG. 1, in the sales data processing device 1 of the present embodiment the mode switch 7 is formed in the upper portion of the case 2. As illustrated in FIG. 3, the mode switch 7 of the present embodiment utilizes a rotary switch in which a key 7a is inserted into a keyhole 7b and rotated in order to selectively change modes.

The selectable modes are settling mode, inspection mode, calculator mode, register mode, OFF mode, return mode, and settings mode. These modes are arranged with prescribed spaces left therebetween around the circumference of the keyhole 7b so as to selectable. Among these, the key 7a can only be inserted and removed at two locations: register mode and OFF mode.

Here, settling mode is selected when settling up a day's sales, for example. More specifically, this mode is for making the printing unit 5 print a day's worth of sales register data stored in the ROM 15 as a journal (settlement report) and for executing a process that deletes that sales register data from the ROM 15. Inspection mode is selected when inspecting sales. Calculator mode is selected when using the sales data processing device 1 as a calculator. Register mode is selected when registering sales. OFF mode is selected when the sales data processing device 1 is not being used. Return mode is selected when processing returned products. Settings mode is selected when customizing operation settings, display settings, and the like for the user.

As illustrated in FIG. 4, the printing unit 5 is arranged within the case 2. After using the thermal printer 5c to print on the continuous paper 9 spooled onto the spooler 5d, the printing unit 5 uses the cutter 5f to cut after each record or continues as-is and uses the feed roller 5e (feed-out device) to feed the paper out from the feed-out opening 5a.

The thermal printer 5c and the cutter 5f are arranged between the spooler 5d and the feed roller 5e and can print and cut while applying a prescribed tension to the continuous paper 9.

The CPU 10 includes, as a functional configuration, the memory control unit 11 and the printing control unit 12. In other words, the CPU 10 executes memory control processes and printing control processes.

Among these, the memory control unit 11 is configured to store sales register data (input data) related to transactions input by the user via the prescribed input unit 4 in the RAM 14 as printing data for receipts (forms).

Moreover, the printing control unit 12 has two printing modes for when starting to print printing data stored in the RAM 14 onto the continuous paper 9: a “print from beginning” printing mode (hereinafter also referred to simply as “print from beginning” or “print-from-beginning printing”) in which the printing data is printed such that a feed-out direction of the continuous paper 9 from the feed-out opening 5a becomes the upwards direction of the receipt 8, and a “print from end” printing mode (hereinafter also referred to simply as “print from end” of “print-from-end printing”) in which the printing data is printed such that the feed-out direction of the continuous paper 9 becomes the downwards direction of the receipt 8.

Furthermore, the printing control unit 12 selectively starts with one printing mode from among these two “print from beginning” and “print from end” printing modes in accordance with amount of free space in the RAM 14.

Among these, in the “print from beginning” printing mode, the printing control unit 12 makes the printing unit 5 start printing immediately after sales register data for a product being sold that has been input is stored in the RAM 14 as printing data by the memory control unit 11.

Next, that printing data can then be deleted so as to use relatively little space in the RAM 14.

In other words, if the amount of free space in the RAM 14 is less than a prescribed threshold value, the “print from beginning” printing mode is started. Here, printing is started in the “print from beginning” printing mode when the amount of free space is less than 50%.

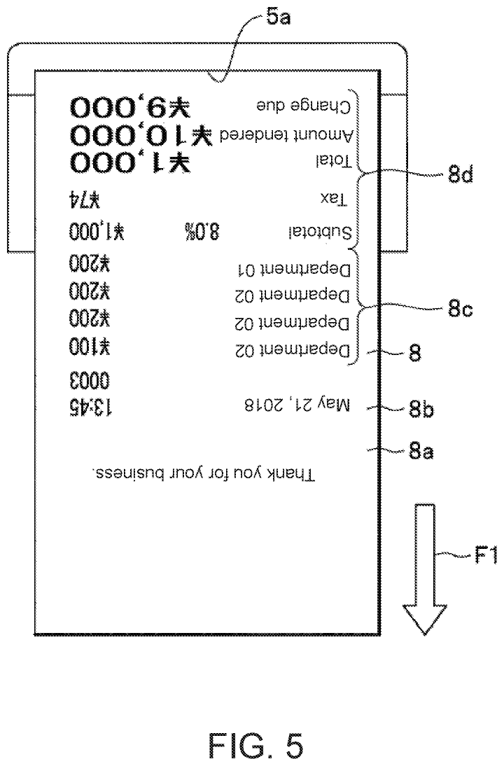

FIG. 5 illustrates an example of a receipt 8 printed in the “print from beginning” printing mode.

In “print from beginning”, greeting text 8a; a date and time and transaction number 8b; sales data 8c; and transaction results 8d including a total, the amount tendered, and the change due are printed sequentially starting from the beginning in a feed-out direction F1 of the receipt 8. In particular, when printing the sales data 8c, the receipt 8 is printed line by line starting from the beginning with the sales data for each product sold as one line of printing data.

Moreover, in the “print from end” printing mode, input data representing sales information that has been input is stored in the RAM 14 as printing data and is later printed all at once as the receipt 8. Thus, in “print from end”, all of the printing data that should be printed on the receipt 8 has to be stored in the RAM 14 in advance, which requires a certain amount of free space.

Therefore, the printing control unit 12 starts “print from end” if the amount of free space in the RAM 14 as of when a total-up input for the transaction is received is greater than or equal to a prescribed threshold value. In the present embodiment, the prescribed threshold value is set to 50%, and if the amount of free space is greater than or equal to 50% the “print from end” printing mode is started and the receipt can be printed starting from the end. This threshold value is stored in the ROM 15 as settings data. Moreover, the threshold value can be changed in accordance with the user.

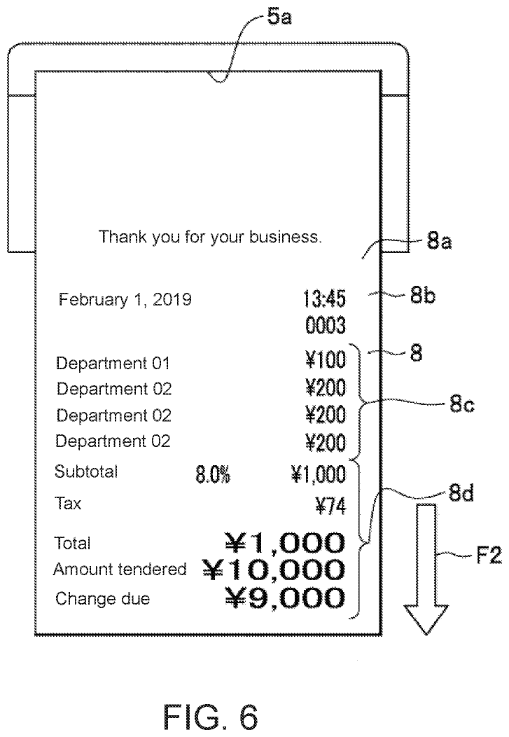

FIG. 6 illustrates an example of a receipt 8 printed in the “print from end” printing mode.

In the “print from end” printing mode, transaction results 8d including a total, the amount tendered, and the change due; sales data 8c; a date and time and transaction number 8b; and greeting text 8a are printed sequentially starting from the end in a feed-out direction F2 of the receipt 8. In particular, when printing the sales data 8c, the receipt 8 is printed line by line starting from the end with the sales register data for each product sold as one line of printing data.

In this way, each line of printing data is printed starting from the last line in the feed-out direction F2 of the receipt 8. Therefore, the printing data printed on the receipt 8 is in the correct direction as viewed by the cashier.

Furthermore, in the sales data processing device 1 of the present embodiment, even if the capacity of the RAM 14 is small, the device can switch to the “print from beginning” printing mode before the RAM 14 runs out of free space so as to continue without stopping the printing process and still be able to utilize “print from end” for data of a certain size that can be stored in the RAM 14.

The memory control unit 11 stores the sales register data for a transaction in the RAM 14 as printing data. While the amount of free space in the RAM 14 is greater than or equal to the prescribed threshold value, the printing control unit 12 starts “print from end” in accordance with the timing at which a total-up input for the transaction is received from the user.

Meanwhile, if the amount of free space in the RAM 14 has become less than the prescribed threshold value, the printing control unit 12 starts “print from beginning” in accordance with the timing at which the amount of free space became less than the prescribed threshold value.

Thus, even if the sales data processing device 1 has a small memory capacity, in states prior to when the RAM 14 runs out of free space the device can always start either “print from end” or “print from beginning”.

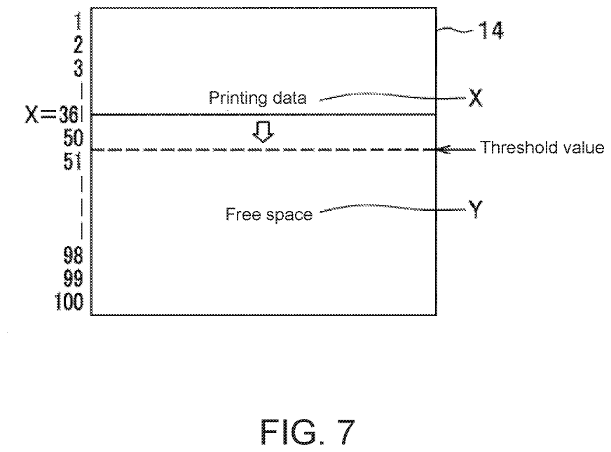

FIG. 7 schematically illustrates a visualization of the space in the RAM 14 of the memory 13. In FIG. 7, the memory capacity of the RAM 14 is artificially set such that 100% is equal to 100 lines (records) in order to simplify the explanation. Thus, the threshold value of 50% at which “print from end” is no longer utilized occurs at a position between lines 50 and 51.

As input is received and the printing data X written to the RAM 14 increases, the amount of free space Y in the RAM 14 decreases (Y=100−X). For example, when the amount of printing data X is X=36, the configured threshold value of 50 has not yet been exceeded and the amount of free space Y is Y=64.

Therefore, by executing a determination based on the amount of free space in the RAM 14 of the memory 13, the printing control unit 12 can determine whether “print from end” can be used.

In the example in FIG. 7, the amount of free space Y=100−36=64 and the amount of free space in the RAM 14 is large, so it can be determined that a surplus is available and “print from end” can be started.

Meanwhile, if the printing data X that has been written increases and exceeds the threshold value of 50%, it can be determined that the amount of free space in the RAM 14 is low and “print from beginning” can be started.

For example, when the receipt 8 fed out from the printing unit 5 is printed from the beginning as illustrated in FIG. 5, the receipt is printed upside-down for the cashier and is difficult to view and read.

On the other hand, when the receipt 8 that is fed out into the hands of the cashier is printed from the end as illustrated in FIG. 6, the printing direction is in the correct direction and the receipt is easy to view and can also be easily read.

Therefore, even if the sales data processing device 1 has a small memory capacity, there is demand to make it possible to utilize “print from end” as much as possible so that the printing is in the correct direction and is readable for the cashier. Furthermore, “print from beginning” is only used when “print from end” is not available due to a lack of memory space. In this way, the printing data is output appropriately and the ease of use of the sales data processing device 1 can be improved.

Here, it is preferable that the threshold value be determined in accordance with the printing performance of the printing unit 5. For example, if the printing performance of the printing unit 5 is five lines per second, then the amount of time required to print the threshold value of 50 lines (50%) in the present embodiment would be 10 seconds. The threshold value should be set such that this required time is the maximum allowable time for use during actual transactions.

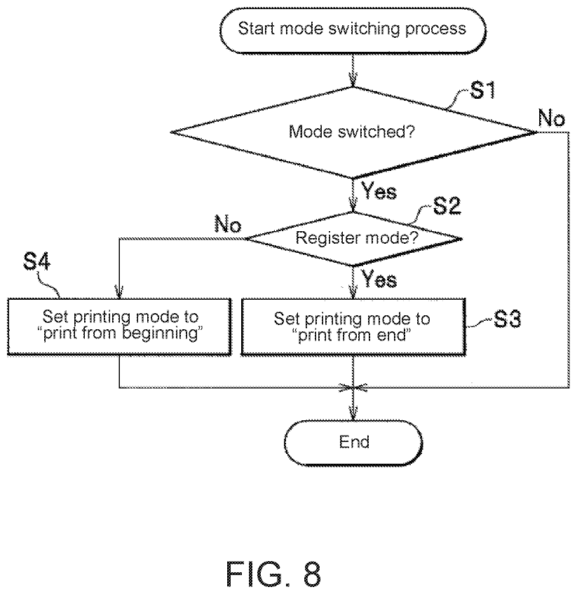

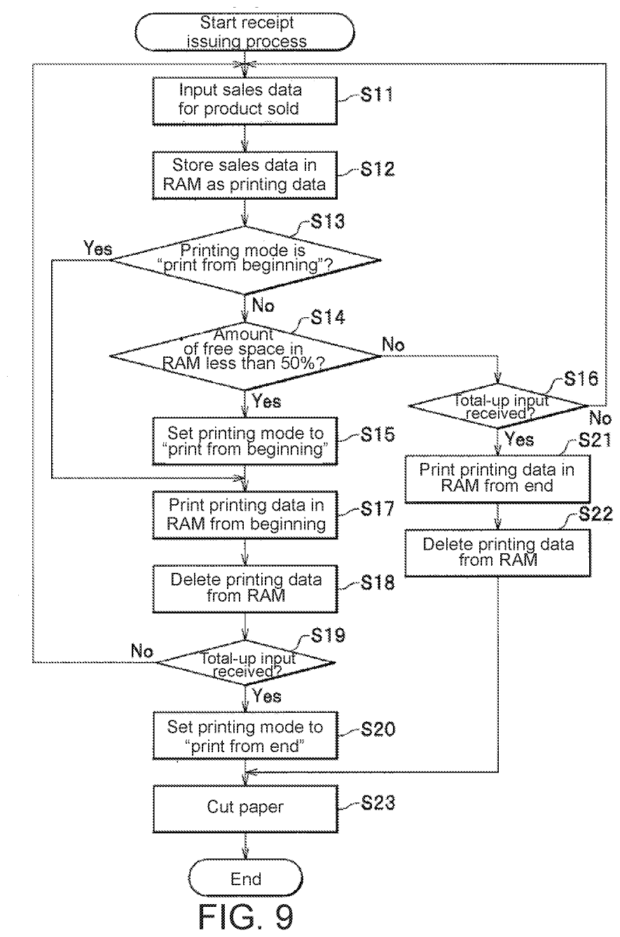

Next, computational processes executed by the CPU 10 of the sales data processing device 1 will be described with reference to the flowcharts in FIGS. 8 and 9.

FIG. 8 is a flowchart for explaining the flow of operations in a mode switching process executed by the sales data processing device 1 of the present embodiment.

First, once the mode switching process starts, in step S1 the CPU 10 determines whether the user has changed the mode using the mode switch 7. In step S1, if the mode has been changed using the mode switch 7 (YES in step S1), the process proceeds to step S2, and if the mode has not been changed using the mode switch 7 (NO in step S1), the mode switching process is ended.

In step S2, the CPU 10 determines whether the mode changed using the mode switch 7 is register mode. If the mode switch 7 has been set to register mode (YES in step S2), the process proceeds to step S3. If the mode switch 7 has not been set to register mode (NO in step S2) and a mode other than register mode such as settling mode has been selected, for example, the process proceeds to step S4.

In step S3, the printing mode is set to “print from end”, and then the mode switching process is ended.

In step S4, the printing mode is set to “print from beginning”, and then the mode switching process is ended.

In this mode switching process, for modes other than register mode such as settling mode and return mode, printing speed is prioritized and the receipt 8 is printed starting from the beginning. Particularly in settling mode, the journal (settlement report), which tends to have a large number of lines of printing data, can be printed from the beginning. This results in better ease of use.

FIG. 9 is a flowchart for explaining the flow of operations in a receipt issuing process executed by the sales data processing device 1 of the present embodiment. Note that although for simplicity the receipt issuing process in FIG. 9 will be described focusing primarily on the portions associated with the sales data 8c of the printing data for the receipt 8 illustrated in FIGS. 5 and 6, in reality, upon starting the receipt issuing process the greeting text 8a and the date and time and transaction number 8b should be stored in the RAM 14 as printing data first. Moreover, the transaction results 8d should be stored in the RAM 14 as printing data when a total-up input (described later) is received.

First, once the receipt issuing process starts, in step S11 the user inputs sales data for a product being sold.

In step S12, the memory control unit 11 of the CPU 10 stores the input sales data in the RAM 14 as printing data.

In step S13, the CPU 10 determines whether the amount of free space in the RAM 14 is less than 50%. If the amount of free space in the RAM 14 is less than 50% (YES in step S13), the process proceeds to step S15, and the printing control unit 12 sets the printing mode to “print from beginning”.

Meanwhile, if the amount of free space in the RAM 14 is not less than 50% (NO in step S13), the process proceeds to step S16.

In step S16, the CPU 10 determines whether a total-up input has been received. If it is determined in step S16 that a total-up input has been received (YES in step S16), the process proceeds to step S21, and if it is determined in step S16 that no total-up input has been received (NO in step S16), the process returns to step S11 and input of sales data is continued.

In step S21, the printing control unit 12 makes the printing unit 5 print the printing data that is stored in the RAM 14 starting from the end.

In step S22, the memory control unit 11 deletes the printing data that is stored in the RAM 14, and the process proceeds to step S23. As a result, the space available in the RAM 14 increases once again.

In step S15, the printing control unit 12 sets the printing mode to “print from beginning”, and the process proceeds to step S17, in which the printing control unit 12 makes the printing unit 5 print the printing data that is stored in the RAM 14 starting from the beginning.

In step S18, the memory control unit 11 deletes the printing data that is stored in the RAM 14, and the process proceeds to step S19.

In step S19, the CPU 10 determines whether a total-up input has been received. If a total-up input has been received in step S19 (YES in step S19), the process proceeds to step S20, and if no total-up input has been received in step S19 (NO in step S19), the process returns to step S11 and input of sales data is continued.

In step S20, the printing mode which was set to “print from beginning” in step S15 is returned to “print from end” for the next receipt issuing process, and the process proceeds to step S23.

In step S23, the continuous paper 9 is fed out from the feed-out opening 5a (see FIG. 1) by the feed roller 5e and is cut by the cutter 5f of the printing unit 5 to become a receipt 8, and the receipt issuing process is ended.

As described above, in accordance with the amount of free space in the RAM 14, the printing control unit 12 selectively starts in one printing mode among “print from beginning” in which the printing data is printed such that the feed-out direction of the receipt 8 becomes the upwards direction of the receipt 8 and “print from end” in which the printing data is printed such that the feed-out direction becomes the downwards direction of the receipt 8. Moreover, when the amount of free space in the RAM 14 is greater than or equal to the prescribed threshold value, “print from end” is selected over “print from beginning,” while when the amount of free space in the RAM 14 is less than the prescribed threshold value, “print from beginning” is selected over “print from end.” In this way, the sales data processing device 1 can output printing data appropriately while considering the amount of free space in the RAM 14.

Therefore, even if the sales data processing device 1 has RAM 14 of a small memory capacity, “print from end” can be utilized within ranges in which the registered printing data does not exceed a prescribed amount of space in the RAM 14.

Moreover, when printing an amount of registered printing data that does exceed the prescribed amount of space in the RAM 14, the device seamlessly switches to “print from beginning” and starts printing from the printing data that was stored in the RAM 14, thereby making it possible to print the printing data that exceeded the prescribed space after this stored printing data and making it possible to print appropriately. In other words, if the amount of free space in the RAM 14 has become less than the prescribed threshold value, “print from beginning” is continued until a total-up input for the transaction is received.

As illustrated in FIG. 6, in “print from end”, the end of the printing is positioned at the bottom as viewed by the cashier, and the printing of the “Thank you for your business” greeting text 8a at the beginning of the printing is positioned at the top.

As a result, the printed side printed on the receipt 8 matches the vertical direction of the cashier's vision and is easy to read. Moreover, the currency inspection space 3b into which the receipt 8 is fed out is on the front side that is nearer to the cashier than the case 2. Therefore, the cashier can take the receipt 8 into hand above the currency inspection space 3b and can immediately confirm the details printed onto the receipt 8 in the correct and easily visible direction.

Note that the present invention is not limited to the embodiments described above, and various changes or modifications can be made without departing from the spirit of the present invention. For example, the embodiments described above were described in detail in order to explain the spirit of the present invention in an easily understandable manner. Therefore, the present invention is not necessarily limited to including all of the described components. Moreover, in the present invention, certain components can have other components added thereto, or certain components can be replaced with other components. Furthermore, in the present invention certain components can be removed.

The memory control unit 11 in the embodiment described above stores sales register data related to transactions input by the user via the prescribed input unit 4 in the RAM 14 as printing data for receipts, but is not particularly limited to this example. For example, the memory control unit 11 may store order data (input data) input by the user via the prescribed input unit 4 in the RAM 14 as printing data for order tickets (forms).

In this case, the printing control unit 12 selectively starts printing the order ticket on the continuous paper 9 using “print from beginning” or “print from end”. Arranging the printing unit 5 in a different location from the case 2, such as in a kitchen, for example, makes it possible to provide an order data printing device that can print easily readable order tickets starting from the end.

Moreover, in this case, the memory control unit 11 stores the order data for an order in the RAM 14 as printing data, and the printing control unit 12 either, while the amount of free space in the RAM 14 is greater than or equal to a prescribed threshold value, starts “print from end” in accordance with a timing at which a total-up input for the order is received from the user, or, if the amount of free space in the RAM 14 has become less than the prescribed threshold value, starts “print from beginning” in accordance with the timing at which the amount of free space became less than the prescribed threshold value.

Furthermore, in this case, if the amount of free space in the RAM 14 has become less than the prescribed threshold value, the printing control unit 12 continues in “print from beginning” until a total-up input for the order is received.

In addition, in the sales data processing device 1 of the present embodiment, when one of the printing modes among “print from beginning” and “print from end” is selectively started in accordance with the amount of free space in the RAM 14, the threshold value for the determination is set to 50% of the amount of free space in the RAM 14.

However, this is not particularly limited, and the threshold value may be set to any value within the range of 1 to 99% of the amount of free space in the RAM 14, for example. It is preferable that the threshold value be set within the range of 30 to 80% and more preferable that the threshold value be set within the range of 45 to 55%, or the like. Moreover, the threshold value may be varied in accordance with printing conditions such as printing time.

Furthermore, although in the sales data processing device 1 of the present embodiment the amount of free space in the RAM 14 is used as the threshold value for making determinations, the present invention is not particularly limited to this configuration. For example, any value that makes it possible to easily estimate the amount of free space out of the total capacity of the RAM 14 (such as the amount of data that has been written to the RAM 14) may be used, and any value that is similar or equivalent to the amount of free space in the RAM 14 may be measured and used as the threshold value.

It will be apparent to those skilled in the art that various modifications and variations can be made in the present invention without departing from the spirit or scope of the invention. Thus, it is intended that the present invention cover modifications and variations that come within the scope of the appended claims and their equivalents. In particular, it is explicitly contemplated that any part or whole of any two or more of the embodiments and their modifications described above can be combined and regarded within the scope of the present invention.

What is claimed is:

1. A printing device, comprising:
a memory; and
a processor that executes the following processes:
a memory control process of sequentially storing input data that are input by a user sequentially via an input unit in the memory as printing data for a form in the order the input data are input; and
a printing control process of, when starting to print the printing data stored in the memory on a printing paper, selectively starting, in accordance with an amount of free space in the memory, one of a print-from-beginning printing in which the printing data are printed in a same order as the order the input data are input such that a feed-out direction of the printing paper becomes an upwards direction of the form and a print-from-end printing in which the printing data are printed in a reversed order relative to the order the input data are input such that the feed-out direction of the printing paper becomes a downwards direction of the form.

2. The printing device according to claim 1,
wherein the input data is sales register data, and
wherein the form is a receipt.

3. The printing device according to claim 1,
wherein the input data is order data, and
wherein the form is an order ticket.

4. The printing device according to claim 1, wherein in the printing control process, the processor starts the print-from-end printing if the amount of free space in the memory is greater than or equal to a prescribed threshold value and starts the print-from-beginning printing if the amount of free space in the memory is less than the prescribed threshold value.

5. The printing device according to claim 2,
wherein in the memory control process, the processor stores sales register data for a transaction in the memory as the printing data,
wherein in the printing control process, when a total-up input for the transaction is received from the user while the amount of free space in the memory is greater than or equal to a prescribed threshold value, the processor starts the print-from-end printing in accordance with a timing at which the total-up input for the transaction is received from the user, and if the amount of free space in the memory has become less than the prescribed threshold value, the processor starts the print-from-beginning printing in accordance with a timing at which the amount of free space became less than the prescribed threshold value.

6. The printing device according to claim 5, wherein in the printing control process, if the amount of free space in the memory has become less than the prescribed threshold value, the processor continues the print-from-beginning printing until the total-up input for the transaction is received.

7. The printing device according to claim 3,
wherein in the memory control process, the processor stores order data for an order in the memory as the printing data, and
wherein in the printing control process, when a total-up input for the order is received from the user while the amount of free space in the memory is greater than or equal to a prescribed threshold value, the processor starts the print-from-end printing in accordance with a timing at which the total-up input for the order is received from the user, and if the amount of free space in the memory has become less than the prescribed threshold value, the processor starts the print-from-beginning printing in accordance with a timing at which the amount of free space became less than the prescribed threshold value.

8. The printing device according to claim 7, wherein in the printing control process, if the amount of free space in the memory has become less than the prescribed threshold value, the processor continues the print-from-beginning printing until the total-up input for the order is received.

9. The printing device according to claim 1, wherein the printing paper is a continuous paper that is wound up in a rolled state.

10. A method of printing executed by a process in the printing device having a memory and said processor, the method comprising:
a memory control step of sequentially storing input data that are input by a user sequentially via an input unit in the memory as printing data for a form in the order the input data are input; and
a printing control step of, when starting to print the printing data stored in the memory on a printing paper, selectively starting, in accordance with an amount of free space in the memory, in one of a print-from-beginning printing in which the printing data are printed in a same order as the order the input data are input such that a feed-out direction of the printing paper becomes an upwards direction of the form and a print-from-end pring in which the printing data are printed in a reversed order relative to the order the input data are input such that the feed-out direction of the printing paper becomes a downwards direction of the form.

11. A non-transitory computer-readable storage medium having stored thereon a program executable by a processor of a printing device that has a memory and said processor, the program causing the processor to perform the following:
a memory control step of sequentially storing input data that are input by a user sequentially via an input unit in the memory as printing data for a form in the order the input data are input; and
a printing control step of, when starting to print the printing data stored in the memory on a printing paper, selectively starting, in accordance with an amount of free space in the memory, in one of a print-from-beginning printing in which the printing data are printed in a same order as the order the input data are input such that a feed-out direction of the printing paper becomes an upwards direction of the form and a print-from-end pring in which the printing data are printed in a reversed order relative to the order the input data are input such that the feed-out direction of the printing paper becomes a downwards direction of the form.
